(19) United States
(12) Patent Application Publication
(10) Pub. No.: US 2026/0157403 A1
(43) Pub. Date: Jun. 11, 2026

(54) CANNED BEVERAGES AND METHODS RELATED THERETO

(71) Applicant: Cryo International LLC, Yardley, PA (US)

(72) Inventors: James Cain, Phoenix, AZ (US); Cameron Jolly, Colorado Springs, CO (US)

(21) Appl. No.: 19/416,209

(22) Filed: Dec. 11, 2025

Related U.S. Application Data
(60) Provisional application No. 63/730,634, filed on Dec. 11, 2024.

(51) Int. Cl. A23L 2/54; A23C 9/152; B67C 7/00

(52) U.S. Cl. CPC A23L 2/54; A23C 9/1524; B67C 7/00; A23C 2210/30

(57) ABSTRACT

Beverages composed of pressurized liquids containing dissolved gas that produce a stable foamy phase or a smooth, thick body when released from a container are described herein.

### CROSS-REFERENCE TO RELATED APPLICATIONS

This application claims priority from U.S. Provisional No. 63/730,634 entitled “Canned Beverages and Methods Related Thereto” filed Dec. 11, 2024, the contents of which are hereby incorporated by reference in their entirety.

### GOVERNMENT INTERESTS

Not applicable

### PARTIES TO A JOINT RESEARCH AGREEMENT

Not applicable

### INCORPORATION OF MATERIAL ON COMPACT DISC

Not applicable

### BACKGROUND

Milkshakes are traditionally prepared from cold or frozen ingredients and consumed immediately to maintain their creamy texture and aerated consistency. Because they rely on refrigeration and on-demand blending, milkshakes have limited portability and are difficult to offer in a convenient, shelf-stable format.

Efforts to create prepackaged or shelf-stable milkshake products have faced challenges. Heat treatments necessary for commercial sterility can cause protein denaturation, flavor degradation, and separation of ingredients. Existing formulations often require high levels of stabilizers and still fail to reproduce the texture and mouthfeel of a freshly made milkshake. Canned products, in particular, present difficulties in maintaining homogeneity, preventing separation, and achieving desirable viscosity or aeration without specialized equipment.

Accordingly, there remains a need for improved formulations and processing methods that allow milkshakes to be packaged in sealed containers-such as cans while preserving the taste and texture expected by consumers. The present invention addresses these unmet needs.

### SUMMARY OF THE INVENTION

Various embodiments of the invention are directed to a pressurized consumable liquid including a consumable liquid having a gas dissolved in the liquid having a concentration of about 0.25 volumes of gas per volume of liquid to about 4.0 volumes of gas per volume of liquid, and a volume of gas sufficient to produce a headspace pressure of about 10 psi to about 60 psi. In some embodiments, the at least one surfactant is a non-gum surfactant selected from the group consisting of lecithin, polysorbate, sodium stearoyl lactylate, sucrose esters, monoglycerides, diglycerides, quillaja extract, saponins, glyceryl monostearate, sorbitan monostearate, sodium caseinate, glycerol esters of fatty acids, propylene glycol esters, propylene glycol alginate, sorbitan monostearate, modified starch, polysorbate 60, polysorbate 80, DATEM (diacetyl tartaric acid ester of monoglycerides), and combinations thereof. In some embodiments, the pressurized consumable liquid further includes a surfactant having a concentration of about 0.1 wt. % to about 1 wt. % based on the total weight of the liquid. In some embodiments, the concentration of gas in the beverage is about 0.5 grams per liter (g/L) to about 8 g/L. In some embodiments, the volume of gas is sufficient to produce a headspace pressure of about 20 psi to about 40 psi. In some embodiments, the consumable liquid contains about 2% to about 6% milkfat and the headspace pressure is about 20 psi to about 27 psi. In some embodiments, the consumable liquid contains about 2% to about 6% plant-based fat and the headspace pressure is about 25 psi to about 35 psi.

Other embodiments of the invention are directed to a consumable liquid in a pressurized container including a sealed container having an internal cavity and a consumable liquid, the consumable liquid at least containing a gas dissolved in the liquid having a concentration of about 0.25 volumes of gas per volume of liquid to about 4.0 volumes of gas per volume of liquid, the internal cavity of the sealed container holding about 75% to about 98% by volume of the consumable liquid and about 2% to about 25% by volume headspace, the headspace having a headspace pressure of about 20 psi to about 40 psi. In some embodiments, the at least one surfactant is a non-gum surfactant selected from the group consisting of lecithin, polysorbate, sodium stearoyl lactylate, sucrose esters, monoglycerides, diglycerides, quillaja extract, saponins, glyceryl monostearate, sorbitan monostearate, sodium caseinate, glycerol esters of fatty acids, propylene glycol esters, propylene glycol alginate, sorbitan monostearate, modified starch, polysorbate 60, polysorbate 80, DATEM, and combinations thereof. In some embodiments, the consumable liquid further includes a surfactant having a concentration of about 0.1 wt. % to about 1 wt. % based on the total weight of the liquid. In some embodiments, the concentration of gas in the beverage is about 0.5 g/L to about 8 g/L. In some embodiments, the consumable liquid contains about 2% to about 6% milkfat and the headspace pressure is about 20 psi to about 27 psi. In some embodiments, the consumable liquid contains about 2% to about 6% plant-based fat and the headspace pressure is about 25 psi to about 35 psi. In some embodiments, depressurizing the container produces a microfoam dispersed within the consumable liquid. In some embodiments, microfoam persists for about 30 minutes to about 5 hours after depressurizing the container.

Additional embodiments of the invention are directed to a method for making a consumable liquid in a pressurized container, the method including filling a container with the consumable liquid, introducing a liquefied gas into the consumable liquid, the amount of liquified gas being sufficient to create a headspace pressure of about 10 psi to about 60 psi when the container is sealed, and sealing the container. In some embodiments, the consumable liquid to liquefied gas has a ratio of about 1:1 to about 30:1. In some embodiments, the method further includes cooling the container and consumable liquid to a temperature of about 32° F. to about 40° F. (about 0° C. to about 4° C.) during filling. In some embodiments, the concentration of liquified gas in the consumable liquid is about 0.5 g/L to about 8 g/L. In some embodiments, the consumable liquid includes about 75% to about 98% by volume of the sealed container and about 2% to about 25% by volume is headspace.

Further embodiments of the invention are directed to methods for making a frothy beverage, the method including filling a container with the consumable liquid, introducing a liquefied gas into the consumable liquid, the amount of liquified gas being sufficient to create a headspace pressure of about 10 psi to about 60 psi when the container is sealed, sealing the container, and opening the container. In some embodiments, the consumable liquid to liquefied gas has a ratio of about 1:1 to about 30:1. In some embodiments, the method further includes cooling the container and consumable liquid to a temperature of about 32° F. to about 40° F. (0° C. to 4° C.) during filling. In some embodiments, the concentration of liquified gas in the consumable liquid is about 0.5 g/L to about 8 g/L. In some embodiments, the consumable liquid includes about 75% to about 98% by volume of the sealed container and about 2% to about 25% by volume is headspace. In some embodiments, opening the container produces a microfoam dispersed within the consumable liquid. In some embodiments, microfoam persists for about 30 minutes to about 5 hours after depressurizing the container. In some embodiments, the frothy beverage contains dairy products, milk, milk substitutes, nut milk, oat milk, or combinations thereof. In some embodiments, the frothy beverage is a dairy-based or non-dairy based milkshake.

### DESCRIPTION OF THE DRAWINGS

Not applicable

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 ml to 8 ml is stated, 2 ml, 3 ml, 4 ml, 5 ml, 6 ml, and 7 ml are also intended to be explicitly disclosed, as well as the range of values greater than or equal to 1 ml and the range of values less than or equal to 8 ml.

The singular forms “a,” “an,” and “the” include plural referents unless the context clearly dictates otherwise. Thus, for example, reference to a “surfactant” includes a single surfactant as well as two or more of the same or different surfactants.

The word “about” when immediately preceding a numerical value means a range of plus or minus 10% of that value, e.g, “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g, more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entirety are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

Various embodiments of the invention described herein include beverages packaged in a sealed, pressurized container that, when opened, expand in volume creating a stable, textured, foamy beverage. In some embodiments, the beverages of such embodiments may include water, milk, or other liquids and their customary ingredients. In other embodiments, the beverage may include an additive such as a gum or surfactant that may aid in foam formation or stabilization. Further embodiments include methods for packaging such beverages to provide shelf stable, non-perishable canned beverages that expand into a stable, textured, foamy beverage.

The beverages of such embodiments may be contained in a container such as a jar, bottle, keg, or can that has been sealed and pressurized with a gas such as, for example nitrous oxide. In some embodiments, the beverage may include a milk or milk-like liquid that contains dairy products, milk, milk substitutes, nut milk, oat milk, and the like and combinations thereof. In other embodiments, the beverages may be water based and free of such milk and milk-like liquids. For example, the beverage may be a liquid such as water, coffee, tea, soft drinks, juice, sports drinks, energy drinks, smoothies, alcoholic beverages, beer, wine, cider, spirits, cocktails, mocktails, sours, fizzes, herbal tea, chai, infused water, lemonade, iced tea, flavored water, hot chocolate, kombucha, protein shakes, egg containing drinks, meal replacement drinks, electrolyte drinks, soda, pop, and the like. The liquids of such embodiments may include substantially the same ingredients as their common counterpart (i.e. its customary ingredients). For example, in particular embodiments, a flavored water or sports drink may include only customary ingredients such as sweeteners (e.g., sugar, honey, artificial, non-saccharide sweeteners, and the like) and artificial or natural flavoring agents (e.g., fruit, mint, cinnamon, caramel, hazelnut, chocolate, and the like). In other embodiments, a flavored water or sports drink may include customary ingredients and additives such as preservatives and stabilizers to improve shelf life.

In further embodiments, the liquids may include the customary ingredients and one or more additives. For example, in some embodiments, a gum may be added to the beverages liquid containing customary ingredients. Gums include, for example, acacia gum (also referred to as gum arabic), guar gum (also referred to as guaran), locust bean gum (also known as carob gum), xanthan gum, carrageenan, or mixtures thereof. As used herein, the term “gums” refer to additives that are incorporated into beverages to stabilize and thicken beverages by absorbing water from the beverage.

In other embodiments, the liquid containing customary ingredients may include a non-gum surfactant such as, for example, lecithin, polysorbate, sodium stearoyl lactylate, sucrose esters, monoglycerides, diglycerides, quillaja extract, saponins, glyceryl monostearate, sorbitan monostearate, sodium caseinate, glycerol esters of fatty acids, propylene glycol esters, propylene glycol alginate, sorbitan monostearate, modified starch, polysorbate 60, polysorbate 80, DATEM (diacetyl tartaric acid ester of monoglycerides), and the like and combinations thereof. As used herein, the term “surfactant” refers to surface-active agents or emulsifiers that reduce the surface tension between different liquids, allowing liquids with different physical properties, for example, hydrophobicity to form stable mixtures.

In certain embodiments, the compositions may contain substantially no gums. In such embodiments, the term “substantially no” means that the concentration of an ingredient, for example, gums, is sufficiently low that the ingredient does not impact the foaminess, frothiness, or texture of the beverage.

The concentration of each of the one or more additives may be from about 0.1 wt. % to about 1 wt. %, about 0.1 wt. % to about 0.9 wt. %, about 0.1 wt. % to about 0.8 wt. %, about 0.1 wt. % to about 0.7 wt. %, about 0.1 wt. % to about 0.6 wt. %, about 0.1 wt. % to about 0.5 wt. %, about 0.1 wt. % to about 0.4 wt. %, about 0.1 wt. % to about 0.3 wt. %, about 0.1 wt. % to about 0.2 wt. %, about 0.25 wt. % to about 1 wt. %, about 0.25 wt. % to about 0.5 wt. %, about 0.5 wt. % to about 1 wt. %, or any range or individual concentration falling within these example ranges.

The beverages of various embodiments further contain a gas. Embodiments are not limited by embodiments and can include carbon dioxide, nitrogen, oxygen, argon, nitrous oxide, and the like and combinations thereof. Such gasses are capable of dissolving in the liquid of the beverage when the beverage is under pressure. The gas may come out of solution under atmospheric pressure causing the liquid portion of the beverage to froth or foam. In some embodiments, agitation of the beverage containing dissolved gasses may augment frothing and foaming and/or change the texture or consistency of the beverage. The person of ordinary skill in the art may determine whether agitation is necessary to achieve desired frothing or foaming.

The amount of dissolved gas in the beverage may vary among embodiments and can be varied to achieve desired texture, consistency, frothiness, and foaminess. For example, in various embodiments, the gas may be present in the beverage at a concentration of about 0.25 volumes of gas per volume of liquid to about 4.0 volumes of gas per volume of liquid. In other embodiments, the concentration of gas in the beverage may be about 0.25 to about 3.5, about 0.25 to about 3.0, about 0.25 to about 2.5 about 0.25 to about 2.0, about 0.25 to about 1.5, about 0.25 to about 1.0, about 0.25 to about 0.5, 0.5 to about 3.5, about 0.5 to about 3.0, about 0.5 to about 2.5 about 0.5 to about 2.0, about 0.5 to about 1.5, about 0.5 to about 1.0, or any range or individual concentration of gas measured in volumes of gas per volume of liquid. In some embodiments, the concentration of gas in the beverage may be about 0.5 grams per liter (“g/L”) to about 8 g/L, about 0.5 g/L to about 7.0 g/L, about 0.5 g/L to about 6.0 g/L, about 0.5 g/L to about 5.0 g/L, about 0.5 g/L to about 4.0 g/L, about 0.5 g/L to about 3.0 g/L, about 0.5 g/L to about 2.0 g/L, about 0.5 g/L to about 1.5 g/L, about 0.5 g/L to about 1.0 g/L, 0.75 grams per liter (“g/L”) to about 8 g/L, about 0.75 g/L to about 7.0 g/L, about 0.75 g/L to about 6.0 g/L, about 0.75 g/L to about 5.0 g/L, about 0.75 g/L to about 4.0 g/L, about 0.75 g/L to about 3.0 g/L, about 0.75 g/L to about 2.0 g/L, about 0.75 g/L to about 1.5 g/L, about 0.75 g/L to about 1.0 g/L, or any range or individual concentration encompassed by these example ranges.

The beverages of various embodiments may include a microfoam dispersed within the liquid phase. The term “microfoam” as used herein describes a liquid having a plurality of entrained gas bubbles substantially smaller than those found in conventional foams. For example, the gas bubbles in a microfoam may be about 10 micrometers (μm) to about 150 μm in diameter. The microfoam of embodiments may be characterized by having very small, uniform bubbles, i.e. having a relatively narrow bubble-size distribution, with a high bubble density, producing a smooth, creamy, and stable froth that enhances the sensory attributes of the beverage when dispensed. In various embodiments, microfoam may be generated in the liquids described above containing dissolved gas that are maintained under pressure. Mechanical agitation and the pressure differential between storage pressure and atmospheric pressure when the maintenance pressure of the beverage is released, may cause the dissolved gas to generate small, uniform bubbles within the range described above, producing microfoam. The presence of microfoam may improve mouthfeel, promote desirable visual characteristics resembling those of, for example, a milkshake. In some embodiments, the amount, texture, or stability of the microfoam may be controlled by adjusting factors such as dissolved-gas content, surfactant concentration, temperature, or container pressure.

Such microfoam may persist for an extended duration due to the small bubble size and resistance to coalescence. For example, in some embodiments, the half-life of the microfoam in a microfoam containing beverage after dispensing may be up to about 5 hours or 6 hours. In various embodiments, the microfoam may remain in the foam phase within the body of the liquid for at least about 10 minutes. In some embodiments, the bubbles may remain in the foam phase or body of the liquid for about 10 minutes to about 5 hours, about 10 minutes to about 4 hours, about 10 minutes to about 2 hours, about 10 minutes to about 1 hour, about 15 minutes to about 45 minutes, about 15 minutes to about 30 minutes, about 15 minutes to about 20 minutes, or any range or individual time encompassed by these example times.

In some embodiments, the beverages, such as dairy, milk, or nutmilk containing beverages may have a high fat content. For example, certain embodiments include beverages having a fat content of about 2% to about 35% fat, about 2% to about 20% fat, about 5% to about 20% fat, about 5% to about 15% fat, about 7% to about 12% fat, or any range or individual value encompassing these example ranges. The fat in such embodiments can be milkfat, plant-based fat, or other animal based fats, such as lard. In some embodiments, beverages having a fat content greater than about 2% or about 5% may produce microfoam without the addition of surfactants. Without wishing to be bound by theory, fatty acids may interact with the dissolved gas in the beverage generating and maintaining microfoam structure and reducing or eliminating the need for surfactants or other additives that perform this function in the beverages. As such, particular embodiments include beverages having a fat content of greater than about 2% or about 5% or any range described above that produce and maintain a stable microfoam structure in the absence of a surfactant.

In certain embodiments, the microfoam producing beverages described above may exhibit a viscosity within a range suitable for delivery through a straw while maintaining a thick, spoonable consistency. For example, in some embodiments, the viscosity of the beverages may be from about 250 cP to about 1500 cP, about 250 cP to about 1200 cP, about 300 cP to about 1000 cP, as measured at 20-25° C., or any range or individual value encompassed by these example ranges. Within this range, the milkshake retains sufficient flowability to enable dispensing by conventional beverage equipment while providing a creamy, slow-flow texture preferred by consumers, while allowing the formulation to maintain consistent rheological properties during storage, dispensing, and consumption.

Various embodiments employ beverage containers formed from metal, glass, plastic, or composite materials having an opening through which the beverage can be served or consumed. In some embodiments, the opening in the beverage container through which the beverage is served, the “aperture” or “curl opening diameter,” can be standard size having a curl opening diameter of about 50 mm to about 60 mm, for example, size 200 or 202 cans. In some embodiments, the beverage container can be configured with non-traditional aperture. For example, the container may include a large-aperture opening having an oversized scored region on the top panel, which, when actuated by a pull tab or lift mechanism that removes a substantial portion of the top of beverage container, creating an expanded drinking or pouring area significantly larger than that of conventional curl opening diameter opening. Examples of beverage containers having a large-aperture opening include containers that incorporate a fully or partially removable top, such as a peel-off lid, hinged lid, or twist-off assembly, enabling users to access the beverage in a manner similar to that of an open cup. These large-aperture and removable-top configurations may enhance user experience by facilitating easier drinking, accommodating the insertion of fruit or flavoring elements, and allowing more efficient cleaning or reuse of the container. Additionally, such designs may be tailored to improve manufacturability, sealing integrity, and compatibility with existing filling and packaging equipment.

The beverage containers of embodiments define an internal cavity bounded by one or more interior surfaces, including an inner sidewall, an inner bottom wall, and an inner surface of the top end. The internal cavity is configured to receive and retain a consumable liquid and may include a substantially cylindrical geometry with a continuous, smooth interior surface to facilitate uniform filling, reduce turbulence during pouring, and prevent residue accumulation. The interior surfaces may further include a food-grade protective coating or liner, such as an epoxy, polyester, or BPA-free polymeric layer, applied to inhibit corrosion, prevent flavor migration, and maintain the integrity of the contained beverage. In some embodiments, the internal cavity may be dimensioned according to the selected container volume and may incorporate optional internal features, such as structural ribs, scoring relief regions, or surface treatments that enhance manufacturability, pressure resistance, or user interaction.

The beverage containers may be of any size and may be provided in any of a wide range of industry-standard volumes to accommodate different product categories and consumer preferences. Exemplary container sizes include small-format volumes such as approximately 185 mL, 200 mL, 237 mL (8 oz), 240-250 mL, and 275-330 mL, which are commonly used for juices, teas, and functional beverages. Additional embodiments may employ mid-size formats such as 335-355 mL (12 oz), 473 mL (16 oz), 500 mL (16.9 oz), 550-568 mL, and 600-710 mL (20-24 oz), suitable for soft drinks, beer, and energy drinks. Larger or specialty beverage containers may include volumes of approximately 750 mL, 1 L, 1.5 L, or 2 L. The disclosed container design may be adapted for use with these and other commercially recognized capacities, including both slim-profile, sleek-profile, and traditional can geometries.

Embodiments include beverage containers holding the compositions of various embodiments described above. The beverage containers of such embodiments include any of the beverage containers discussed above having sealed within the internal cavity an amount of any of the various beverages described above, the “liquid contents” of the container, and an amount of any of the gasses described above occupying the “headspace” of the beverage container. In such embodiments, headspace may be sized to hold sufficient gas to allow dissolution of the gas into the liquid contents of the beverage container and provide enough space to hold the beverage when the container is opened and the volume of liquid contents expands. In some embodiments, the container may be filled so that the liquid occupies about 75% to about 98% of the internal cavity volume (at ambient temperature, 20° C.), leaving a headspace of about 2% to about 25% of the internal cavity volume for expansion, carbonation, and pressure control. In other embodiments, the container may be filled so that the liquid occupies about 75% to about 90% of the internal cavity volume, about 80% to about 90% of the internal cavity volume, or any volume encompassed by these ranges, producing a headspace of about 10% to about 25% or about 10% to about 20% of the internal cavity volume for expansion, carbonation, and pressure control.

In various embodiments, the headspace pressure may be about 10 psi to about 60 psi. In other embodiments, the headspace pressure of the container may be about 10 psi to about 50 psi, about 10 psi to about 40 psi, about 10 psi to about 30 psi, about 10 psi to about 20 psi, about 20 psi to about 50 psi, about 20 psi to about 40 psi, about 20 psi to about 30 psi, or any range or individual pressure encompassed by these example ranges.

In some embodiments, the fat content of the liquid contents of the beverage container may dictate the headspace pressure. In embodiments in which the liquid contents of the container has a high fat content, such as a dairy or milk containing beverage, the pressure may be lower than a container having the same dimensions containing, for example, a non-dairy or nut milk containing beverage. For example, certain embodiments encompass a beverage container enclosing a dairy or milk containing beverage. Such beverages may generally have a milkfat content of about 2% to about 6% fat, about 3% to about 4% milkfat, or higher if the beverage contains half-and-half or cream and a headspace pressure of about 20 psi to about 27 psi. In other embodiments, a beverage container enclosing a non-dairy or nut milk containing beverage with a fat content of about 2% to about 6% plant-based fat may have a headspace pressure of about 25 psi to about 35 psi. Without wishing to be bound by theory, short-chain and medium-chain fatty acids characteristic of milk fats may be better suited to generate and maintain microfoam structure than long chain fatty acids found in the plant-based fats of nut-milk allowing sufficient microfoam to develop at lower pressures, although proteins specific to milk such as caseins and whey may add to this effect. The liquid portion of such beverage containers may have similar texture, consistency, mouth feel, and microfoam structure despite having different fat contents and being stored at different headspace pressures.

In certain embodiments, the beverage container may be configured to be shaken or otherwise agitated prior to dispensing to ensure proper mixing of the formulation, dispersal of the dissolved gas in the beverage, and production of microfoam. During storage, components such as dairy solids, sweeteners, emulsifiers, or particulates may undergo partial settling or phase separation. Agitation of the sealed can, such as by manual shaking for 2-10 seconds, may redistribute these components and restore a uniform microfoam production, viscosity, and texture suitable for consumption. This pre-dispense agitation step enhances homogeneity, improves flow characteristics upon opening, and enables the beverage to achieve its intended creamy consistency without the need for specialized equipment. In various embodiments, instructions for shaking may be provided on the container or integrated into the product design to ensure consistent consumer use.

Additional embodiments include methods for making the beverages described above. For example, in some embodiments, the liquid portion of the beverage may be prepared using methods customarily used in the art. The prepared liquid may be introduced into a container, filling the container, and the container may be sealed. The steps of filling and sealing can be carried out by any method known in the art. After sealing the liquid in the container, a gas may be introduced into the liquid by, for example, injecting gas into the container through a one-way valve disposed on a wall of the container. The step of pressurizing the container can be carried out to an internal pressure that allows sufficient gas to be dissolved in the liquid portion of the beverage to achieve the desired texture, consistency, frothiness, and foaminess when the gas is released from the liquid when the container is opened. For example, in various embodiments, the gas can be injected into the container until an internal pressure, e.g. a headspace pressure, of about 10 psi to about 60 psi is established. In other embodiments, the internal pressure of the container may be about 10 psi to about 50 psi, about 10 psi to about 40 psi, about 10 psi to about 30 psi, about 10 psi to about 20 psi, about 20 psi to about 50 psi, about 20 psi to about 40 psi, about 20 psi to about 30 psi, or any range or individual pressure encompassed by these example ranges. In some embodiments, pressurization may be carried out until the liquid portion of the beverage is saturated with gas.

In other embodiments, the gas may be introduced by combining the liquid portion of the beverage with a liquified gas. For example, the liquid portion of the beverage may be prepared using methods customarily used in the art. In some embodiments, the prepared liquid may be introduced into a container, a liquified gas, such as liquid oxygen, liquid nitrogen, liquid argon, or liquid nitrous oxide, can be added to the container, and the container may be sealed. In other embodiments, the prepared liquid may be combined with a liquified gas before being introduced into the container. For example, methods may include combining a prepared liquid with a liquefied gas, introducing the combined liquids into a container and sealing the container. The steps of filling and sealing can be carried out by any method known in the art. After sealing the liquid in the container, a gas may be introduced into the liquid by, for example, injecting gas into the container through a one-way valve disposed on a wall of the container. The step of pressurizing the container can be carried out to an internal pressure that allows sufficient gas to be dissolved in the liquid portion of the beverage to achieve the desired texture, consistency, frothiness, and foaminess when the gas is released from the liquid when the container is opened. In other embodiments, a portion of the liquified gas may be released from the liquid pressurizing the container without the addition of a gas.

In such embodiments, the liquified gas portion of the combined prepared liquid and liquefied gas can be selected to achieve the desired internal pressure and to achieve the desired texture, consistency, frothiness, and foaminess when the gas is released from the liquid when the container is opened. For example, in various embodiments, the ratio of prepared liquid to liquefied gas may be about 1:1, about 2:1, about 3:1, about 5:1, about 10:1, about 15:1, about 20:1, about 30:1, about 50:1, about 100:1, or any ratio encompassed by these example ratios. The amount of liquified gas incorporated into the prepared beverage can vary among embodiments and can be determined by the person of ordinary skill in the art based on known factors including, for example, solubility of the gas in the prepared liquid and the time period between combining the prepared liquid to liquefied gas and sealing the container into which the composition is dispensed among other factors. In general, the amount of liquified gas incorporated into the prepared liquid may be sufficient to create an internal pressure, e.g. a headspace pressure, of about 10 psi to about 60 psi or any of the individual pressures or ranges identified above.

In some embodiments, the container and the liquid components therein may be cooled during pressurizing to promote gas dissolution, reduce foam formation during filling, and stabilize the resulting beverage structure. For example, methods may include cooling the container to a temperature of about 32° F. to about 40° F. (about 0° C. to about 4° C.) during filling and pressurizing. Cooling the container and beverage to this range may facilitate increased solubility of dissolved gases, such as carbon dioxide or nitrogen, enable more precise control of headspace pressure, and improve the formation and stability of microfoam or other aerated structures upon opening. In certain embodiments, the cooled state is maintained throughout at least a portion of the filling, sealing, and pressurizing process to ensure consistent internal pressure and to reduce thermal expansion effects that could otherwise result in elevated headspace pressure at ambient storage temperatures.

In some embodiments, the method may include the step of agitating the sealed container during or after pressurizing the container to increase dissolution of the gas in the liquid portion of the container. Agitating can be carried out using, for example, commercial gasser-shaker that simultaneously agitating while introducing gas into the container or gas can be added in a stepwise manner, by adding a first portion of the gas to the container, agitating the container, adding a second portion of the gas to the container, agitating the container, and so on until sufficient gas in introduced into the container to obtain the desired pressure.

The methods described above may include various additional steps that improve the process and/or to achieve desired texture, consistency, frothiness, and foaminess of the beverage. For example, the step of preparing the liquid portion of the beverage can be carried out by mixing the ingredients of the beverage at a rate that avoids dissolution of air gasses in the liquid. In some embodiments, the methods may include introducing individual ingredients or particular individual ingredients into the liquid in a specific order. In some embodiments, the methods include sterilizing the liquid portion of the beverage before or after introducing the liquid into the container. The step of sterilizing can be carried out using any method known in the art including pasteurization and sonication.

Beverages canned or bottled using the methods described above can be stored for various amounts of time before being delivered to a consumer who may consume the beverage.

The beverages described above can be served by opening the container and pouring the gas-saturated liquid into a drinking vessel. The gas-saturated liquid will expand in volume once poured out of the container. Therefore, the drinking vessel may have a greater volume than the amount of the gas-saturated liquid to be poured into it, or two or more drinking vessels may be used to contain the gas saturated liquid.

In other embodiments, the container may include an empty or gas filled space separate from the liquid. For example, the container may have a volume that is substantially larger than the volume of the liquid, so that the expansion of the liquid is contained within the container once opened. In another example, the container may include a reversible first sealed interior compartment that holds the pressurized liquid and an empty second interior compartment. When the container is opened, the seal is broken allowing the pressurized liquid to expand into the empty second interior compartment.

Expansion of the liquid occurs as a result of the release of dissolved gas from the pressurized liquid when the container is opened and the internal pressure of the container is reduced to atmospheric pressure. After exiting the solution, the previously dissolved gas forms bubbles in the liquid expanding the liquid and increasing its volume. In some embodiments, the bubbles of released gas may form a foam phase that is separate from the remaining liquid. In other embodiments, the bubbles of released gas may remain within the body of the liquid producing a smooth, creamy beverage with a dense, rich body.

In various embodiments, the bubbles may remain in the foam phase or body of the liquid for at least about 1 minute, at least about 3 minutes, at least about 5 minutes, and at least about 10 minutes. In some embodiments, the bubbles may remain in the foam phase or body of the liquid for about 10 minutes to about 1 hour, about 10 minutes to about 45 minutes, about 10 minutes to about 30 minutes, about 10 minutes to about 20 minutes, about 5 minutes to about 45 minutes, about 5 minutes to about 30 minutes, about 5 minutes to about 20 minutes, about 5 minutes to about 10 minutes, about 1 minutes to about 20 minutes, about 1 minutes to about 15 minutes, about 1 minutes to about 10 minutes, about 1 minutes to about 5 minutes, about 1 minutes to about 3 minutes, or any range or individual time encompassed by these example times.

1. A pressurized consumable liquid comprising:
a consumable liquid having:
a gas dissolved in the liquid having a concentration of about 0.25 volumes of gas per volume of liquid to about 4.0 volumes of gas per volume of liquid; and
a volume of gas sufficient to produce a headspace pressure of about 10 psi to about 60 psi.

2. The pressurized consumable liquid of claim 1, wherein the at least one surfactant is a non-gum surfactant selected from the group consisting of lecithin, polysorbate, sodium stearoyl lactylate, sucrose esters, monoglycerides, diglycerides, quillaja extract, saponins, glyceryl monostearate, sorbitan monostearate, sodium caseinate, glycerol esters of fatty acids, propylene glycol esters, propylene glycol alginate, sorbitan monostearate, modified starch, polysorbate 60, polysorbate 80, DATEM (diacetyl tartaric acid ester of monoglycerides), and combinations thereof.

3. The pressurized consumable liquid of claim 1, further comprising a surfactant having a concentration of about 0.1 wt. % to about 1 wt. % based on the total weight of the liquid.

4. The pressurized consumable liquid of claim 1, wherein the concentration of gas in the beverage is about 0.5 grams per liter (g/L) to about 8 g/L.

5. The pressurized consumable liquid of claim 1, wherein the volume of gas is sufficient to produce a headspace pressure of about 20 psi to about 40 psi.

6. The pressurized consumable liquid of claim 1, wherein the consumable liquid contains about 2% to about 6% milkfat and the headspace pressure is about 20 psi to about 27 psi.

7. The pressurized consumable liquid of claim 1, wherein the consumable liquid contains about 2% to about 6% plant-based fat and the headspace pressure is about 25 psi to about 35 psi.

8. A consumable liquid in a pressurized container comprising:
a sealed container having an internal cavity; and
a consumable liquid, the consumable liquid at least containing a gas dissolved in the liquid having a concentration of about 0.25 volumes of gas per volume of liquid to about 4.0 volumes of gas per volume of liquid;
the internal cavity of the sealed container holding about 75% to about 98% by volume of the consumable liquid and about 2% to about 25% by volume headspace;
the headspace having a headspace pressure of about 20 psi to about 40 psi.

9. The consumable liquid in a pressurized container of claim 8, wherein the at least one surfactant is a non-gum surfactant selected from the group consisting of lecithin, polysorbate, sodium stearoyl lactylate, sucrose esters, monoglycerides, diglycerides, quillaja extract, saponins, glyceryl monostearate, sorbitan monostearate, sodium caseinate, glycerol esters of fatty acids, propylene glycol esters, propylene glycol alginate, sorbitan monostearate, modified starch, polysorbate 60, polysorbate 80, DATEM (diacetyl tartaric acid ester of monoglycerides), and combinations thereof.

10. The consumable liquid in a pressurized container of claim 8, further comprising a surfactant having a concentration of about 0.1 wt. % to about 1 wt. % based on the total weight of the liquid.

11. The consumable liquid in a pressurized container of claim 8, wherein the concentration of gas in the beverage is about 0.5 grams per liter (g/L) to about 8 g/L.

12. The consumable liquid in a pressurized container of claim 8, wherein the consumable liquid contains about 2% to about 6% milkfat and the headspace pressure is about 20 psi to about 27 psi.

13. The consumable liquid in a pressurized container of claim 8, wherein the consumable liquid contains about 2% to about 6% plant-based fat and the headspace pressure is about 25 psi to about 35 psi.

14. The consumable liquid in a pressurized container of claim 8, wherein depressurizing the container produces a microfoam dispersed within the consumable liquid.

15. The consumable liquid in a pressurized container of claim 14, wherein microfoam persists for about 30 minutes to about 5 hours after depressurizing the container.

16. A method for making a consumable liquid in a pressurized container; the method comprising:
filling a container with the consumable liquid;
introducing a liquefied gas into the consumable liquid, the amount of liquified gas being sufficient to create a headspace pressure of about 10 psi to about 60 psi when the container is sealed; and
sealing the container.

17. The method of claim 16, wherein the consumable liquid to liquefied gas has a ratio of about 1:1 to about 30:1.

18. The method of claim 16, further comprising cooling the container and consumable liquid to a temperature of about 32° F. to about 40° F. (about 0° C. to about 4° C.) during filling.

19. The method of claim 16, wherein the concentration of liquified gas in the consumable liquid is about 0.5 grams per liter (g/L) to about 8 g/L.

20. The method of claim 16, wherein consumable liquid comprises about 75% to about 98% by volume of the sealed container and about 2% to about 25% by volume is headspace.
